(19) United States
(12) Patent Application Publication
(10) Pub. No.: US 2025/0253360 A1
(43) Pub. Date: Aug. 7, 2025

(54) STORAGE CONTAINER FOR TEMPORARILY STORING A TEMPERATURE CONTROL AGENT

(71) Applicant: MAHLE International GmbH, Stuttgart (DE)

(72) Inventors: Ralf Zink, Stuttgart (DE); Markus Lang, Loechgau (DE)

(21) Appl. No.: 19/043,457

(22) Filed: Feb. 1, 2025

(30) Foreign Application Priority Data
Feb. 1, 2024 (DE) 102024102850.5

(51) Int. Cl. H01M 8/04044; H01M 8/04029; H01M 10/613; H01M 10/625; H01M 10/6567

(52) U.S. Cl. CPC H01M 8/04044; H01M 8/04029; H01M 10/613; H01M 10/625; H01M 10/6567; H01M 2220/20; H01M 2250/20

(57) ABSTRACT

A storage container includes a housing that encloses a housing interior, through which the temperature control agent can flow for intermediate storage. The housing includes a fluid inlet and outlet, each with respective openings for introducing and discharging the temperature control agent. A housing opening provides fluid communication between the housing interior and the external environment. A sealing element is positioned in the housing opening to seal it in a fluid-tight manner when arranged. A drying device, positioned on the sealing element, absorbs moisture from the temperature control agent within the housing interior. The drying device is arranged within the housing interior, while the sealing element remains positioned in the housing opening.

### CROSS REFERENCE TO RELATED APPLICATION

This application claims priority to German Patent Application No. DE102024102850.5, filed on Feb. 1, 2024, the contents of which is hereby incorporated by reference in its entirety.

### TECHNICAL FIELD

The present invention relates to a storage container for the intermediate storage of a temperature control agent and to a temperature control arrangement with such a storage container.

### BACKGROUND

A vehicle battery can be immersion-cooled in a temperature control circuit with a temperature control agent such as oil. In order to remove unwanted moisture from the temperature control agent, it is common practice to integrate a drying device containing a drying agent into the temperature control circuit, which is able to absorb and store the moisture present in the temperature control agent. In conventional temperature control circuits, such a drying device is included, for example, in a filter device that is also present in the temperature control circuit and is used to separate dirt particles and the like from the temperature control agent.

### SUMMARY

The task of this invention is therefore to identify new approaches for developing solutions for improved drying of temperature control agents for a temperature control circuit, which in particular is accompanied by a reduced pressure loss in the temperature control agent.

This object is achieved by the scope of the independent claim(s). Preferred embodiments are the scope of the dependent claim(s).

The basic idea of the invention is therefore to provide the drying device described above for absorbing moisture from a temperature control agent in a storage container arranged in a temperature control circuit for storing the temperature control agent. Such a storage container can store a not insignificant amount of temperature control agent in order to compensate for temperature-related volume expansions of the cooling system.

Since such a storage container requires more space than the filter device mentioned at the beginning, a drying device can be integrated into the storage container in such a way that it only causes a comparatively small pressure loss in the temperature control agent, which in any case is significantly lower than with the previously practiced arrangement of the drying device in a filter device. As a result, the solution according to the invention as described above allows for effective drying of the temperature control agent with a simultaneously low pressure loss.

In accordance with the inventive concept explained above, a storage container for holding a temperature control agent according to the invention comprises a housing which surrounds a housing interior through which a temperature control agent can flow for the intermediate storage of the temperature control agent. The temperature control agent may in particular be an oil. In particular, a temperature control agent known to the person skilled in the art under the designation “Mobil Therm Elite” may be considered as the temperature control agent or oil for the temperature control circuit. If the storage container is arranged in a temperature control circuit, the temperature control agent received in the housing interior can be used directly to flow through the temperature control circuit. In this case, the housing interior is therefore directly integrated into the temperature control circuit. In order to be able to integrate the storage container into the temperature control circuit, the storage container comprises a fluid inlet arranged on the housing and having an inlet opening, through which temperature control agent can be introduced into the housing interior. Furthermore, the storage container also comprises a fluid outlet arranged on the housing and having an outlet opening, via which temperature control agent can be discharged from the housing interior.

Furthermore, the storage container comprises a housing opening provided in the housing, via which the housing interior communicates fluidically with an external environment of the housing. This housing opening is therefore formed in addition to the inlet opening and the outlet opening on the housing. In addition, the storage container comprises a sealing element for closing the housing opening and consequently for positioning in the housing opening. When arranged in the housing opening, the sealing element seals the housing opening in a fluid-tight manner. According to the invention, a drying device for absorbing moisture from the temperature control agent present in the housing interior is arranged on the sealing element.

The drying device is arranged in the housing interior while the sealing element is arranged in the housing opening. Thus, the drying device can dehumidify the temperature control agent present in the housing interior or flowing through the housing interior. Due to the comparatively large volume of the housing interior—in particular compared to the filter device mentioned at the beginning—the pressure reduction caused by the drying device in the temperature control agent is low.

In a preferred embodiment, the drying device is designed so that the temperature control agent can flow through it. This allows an effective interaction of the drying agent present in the drying device with the temperature control agent to be dehumidified.

Particularly preferably, the drying device can be partially accommodated in a receptacle provided in the housing interior and communicating fluidically with the outlet opening, so that the temperature control agent flowing through the housing interior must flow through the drying device before reaching the outlet opening. This ensures that all temperature control agent entering the storage container is subjected to dehumidification by means of the drying device. This achieves particularly effective drying of the temperature control agent.

According to an advantageous further development of the storage container according to the invention, the receptacle can be designed as an opening collar which projects inwards from the housing into the housing interior and which projects from the inlet opening, and into which the drying device can be partially inserted or is inserted. In this way, the drying device can be stably fixed in the housing interior. This proves to be particularly advantageous when the storage container with the drying device is used in a motor vehicle, where it can be exposed to not insignificant external forces, in particular in the form of mechanical shocks and impacts.

According to a further advantageous development, the sealing element can be designed as a screw-in screw plug that can be screwed into the housing opening. This variant has a technically simple design and can therefore be realized cost-effectively.

Particularly preferably, the drying device and the housing opening can be arranged in the housing interior and on the housing and matched to one another such that the drying device, when the sealing element is accommodated in the housing opening, protrudes into the housing interior. In this case, the drying device can act on the temperature control agent stored in the housing interior or flowing through the housing interior. Since no additional space is required to arrange the drying, this embodiment also proves to be space-saving.

In another preferred embodiment, the inlet opening and the housing opening can be arranged in a first housing wall of the housing. Furthermore, in this embodiment, the outlet opening is arranged in a second housing wall of the housing, which is opposite the first housing wall. This ensures that a large proportion of the temperature control agent present in the storage container, ideally all of the temperature control agent present in the housing interior, also participates in the flow of the temperature control circuit in which the storage container is arranged.

In another preferred embodiment, the drying device is elongated and extends from the first housing wall along a longitudinal direction to the second housing wall. A longitudinal extension of the drying device, measured in the longitudinal direction, is at least three times greater than a transverse extension, measured perpendicular to the longitudinal direction.

Such a configuration requires that the temperature control agent circulating in a temperature control circuit must flow at least through the volume of the housing interior present between the two housing walls, which increases the probability of an interaction with the drying agent present in the drying device.

Another embodiment of the storage container according to the invention has proven to be particularly advantageous, in which the first housing wall forms a top surface of the housing and the second housing wall forms a bottom surface of the housing in a preferred position of use of the storage container with respect to the direction of gravity. This ensures that the air, which is lighter than the temperature control agent and is therefore arranged above the temperature control agent in the housing interior, does not enter the temperature control circuit via the outlet.

According to a further advantageous design, the drying device comprises a permeable enclosure for the temperature control agent, which surrounds a drying agent for absorbing moisture contained in the drying agent. A drying device constructed in this way is technically particularly easy to implement and thus also inexpensive to manufacture. In particular, a granular drying agent can be used, particularly preferably a zeolite, a molecular sieve, or a silica gel.

Particularly preferably, the enclosure can consist of a flexible material or comprise such a flexible material. Particularly preferably, the enclosure can be formed by a bag made of fiber material, in particular made of polyester, polyoxymethylene, or polyamide, or by a fine-mesh sieve, in particular made of polyester, polyoxymethylene, polyamide, or stainless steel.

It is particularly preferred that the drying device is firmly attached to the sealing element. This facilitates the “handling” of the drying device with the screw plug by an operator.

According to another advantageous further development, the drying device is designed as a cartridge that can be detached from the sealing element or screw plug, with a cartridge housing that is permeable to the temperature control agent, in which the drying agent is arranged in such a way that it can come into contact with the temperature control agent flowing around the drying device and thus absorb moisture from it. The cartridge design makes it easy to replace the drying device, for example when the drying agent has reached its maximum moisture absorption capacity. In this case, the cartridge can easily be replaced with a spare cartridge. To do this, simply remove the sealing element or screw plug from the housing opening and then release the cartridge from the sealing element or screw. Accordingly, a replacement cartridge with unused pressure medium is attached to the sealing element or screw plug and mounted on the housing together with the sealing element or screw plug.

Particularly preferably, the drying device is detachably attached to the sealing element by means of a bayonet lock. Such a bayonet lock is technically easy to implement and allows easy disassembly and assembly of the drying device, in particular if the drying device is designed as a cartridge.

According to a further advantageous development, the bayonet lock comprises a pretensioning element, in particular a compression spring, for fixing the drying device to the scaling element. The pretensioning element or compression spring compresses the drying agent and prevents mutual rubbing within the drying agent. This counteracts wear and tear and the accumulation of dirt.

The invention also relates to a temperature control arrangement for controlling the temperature of a component. The temperature control arrangement according to the invention comprises a temperature control circuit in which a temperature control agent can be circulated and, in particular, is circulated during operation. The component to be temperature-controlled is also arranged in this temperature control circuit so that heat can be transferred between the component and the temperature control agent. Furthermore, the temperature control arrangement comprises a conveying device, in particular in the form of a fluid or oil pump, for circulating the temperature control agent in the temperature control circuit. According to the invention, a storage container, as presented above and thus according to the invention, is arranged in the temperature control circuit for the intermediate storage of the temperature control agent. The advantages of the storage container according to the invention, as explained above, are therefore also transferred to the temperature control arrangement according to the invention.

In a preferred embodiment of the temperature control arrangement according to the invention, the component to be temperature-controlled is or comprises an electric battery, in particular of a motor vehicle, or a fuel cell system having at least one fuel cell. The fuel cell system can also be part of a motor vehicle or, alternatively, a stationary fuel cell system.

In a particularly preferred embodiment, the component to be temperature-controlled can be arranged in the temperature control circuit so that the temperature control agent flows directly around it. This type of temperature control or cooling is known as “immersion cooling” and allows particularly efficient temperature control or cooling of the said component.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWING

The following is shown—schematically in each case—in the images below:

FIG. 1 is a sectional view of an example of a storage container according to the invention; and

FIG. 2 is an example of a temperature control circuit according to the invention in a rough schematic diagram.

### DETAILED DESCRIPTION

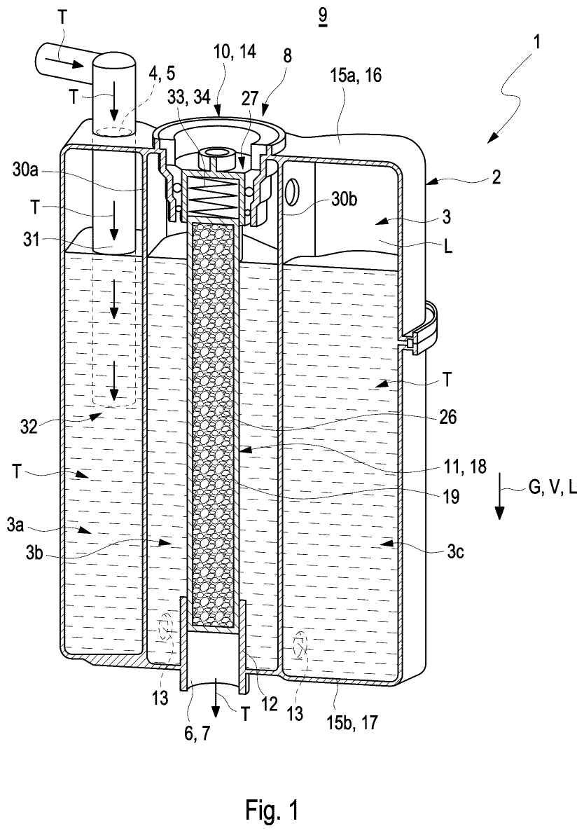

FIG. 1 illustrates in a sectional view an example of a storage container 1 for the intermediate storage of a temperature control agent T according to the invention. The storage container 1 comprises a housing 2 which surrounds a housing interior 3 through which the temperature control agent T can flow, for holding the temperature control agent T. The storage container 1 also comprises a fluid inlet 5 arranged on the housing 2 and having an inlet opening 4 for introducing the temperature control agent T into the housing interior 3. Furthermore, the storage container 1 comprises a fluid outlet 7, also arranged on the housing 2 and having an outlet opening 6, for discharging the temperature control agent from the housing interior 3.

The inlet opening 4 and housing opening 8 are arranged in a first housing wall 15a of the housing 2 in the example scenario of FIG. 1. In contrast, outlet opening 6 is arranged in a second housing wall 15b of the housing 2, which is opposite the first housing wall 15a.

In a preferred position of use of the storage container I with respect to the direction of gravity G, the first housing wall 15a forms a top surface 16 of the housing 2, whereas the second housing wall 15b forms a bottom surface 17 of the housing 2.

As can be seen in FIG. 1, the temperature control agent T is arranged in a lower region of the housing interior 3 due to the force of gravity. In the position of use of the storage container 1 shown, air L can be arranged as a compensating volume above the temperature control agent T in the housing interior 3 (see FIG. 1). This air L can be compressed by the temperature control agent T when the latter expands, for example due to temperature. In order to ensure that the air L remains in the housing interior 3 of the storage container 1 and cannot escape from the storage container 1 via the outlet 6, the outlet 6 is arranged in a bottom surface 17 of the housing 2. Accordingly, as shown in FIG. 1, a pipe socket 31 can project from the housing opening 5 or from the inlet 4 into the housing interior 3, via which the temperature control agent T is introduced into a region 32, arranged below the air L, of the housing interior 3, which is filled with the temperature control agent T. This prevents turbulence from occurring in the air L present in the upper part of the housing interior 3, which could also be accompanied by an undesired escape of air L from the storage container 1.

According to FIG. 1, the storage container 1 comprises a housing opening 8 provided in the housing 2, via which the housing interior 3 communicates fluidically with an external environment 9 of the housing 2. This housing opening 8 is provided in addition to the inlet opening 5 and the outlet opening 7 on the housing 2.

In addition, the storage container 1 comprises a sealing element 10 for closing the housing opening 8 and can be arranged in the housing opening 8 for this purpose. The sealing element 10 can be advantageously designed as a screw plug 14 that can be screwed into the housing opening 8. When arranged in the housing opening 8, the sealing element 10 seals the housing opening 8 in a fluid-tight manner. A drying device 11 for absorbing moisture from the temperature control agent T present in the housing interior 3 and striking the drying device 11 is arranged on the scaling element 10. In the example, the drying device 11 is firmly connected to the sealing element 10. The drying device 11 is thus arranged in the housing interior 3 in a state of the sealing element 10 arranged in the housing opening 8. The drying device 11 and the housing opening 8 are preferably arranged and matched to one another, as shown in the example scenario in FIG. 1, such that the drying device 11, when the sealing element 10 is accommodated in the housing opening 8, protrudes from the latter into the housing interior 3.

As can be seen from FIG. 1, the drying device 11 is of elongate design and extends away from the first housing wall 15a along a longitudinal direction L, which extends preferably parallel to the direction of gravity G, towards the second housing wall 15b. The drying device 11 can be partially accommodated in a receptacle 12 provided in the housing interior 3 and communicating fluidically with the outlet opening 6. The exception 12 is designed in such a way that when the drying device 11 is accommodated in the receptacle 12, the temperature control agent T flowing through the housing interior 3 must flow through the drying device 11 before reaching the outlet opening 6. The said receptacle 12 can be designed as an opening collar, as shown in FIG. 1, which projects inwards from the housing 2 into the housing interior 3 and projects from the inlet opening 4, and into which the drying device 11 can be partially inserted or pushed.

As shown in FIG. 1, the drying device 11 is designed as a cartridge 18 that can be detached from the sealing element 10 or the screw plug 10, with a cartridge housing 19 that is permeable to the temperature control agent T, in which a drying agent 26, for example a zeolite, a molecular sieve, or a silica gel, is arranged in such a way that it can come into contact with the temperature control agent T flowing around the drying device 11 and thus absorb moisture from the temperature control agent T. The drying device 11 can be detachably attached to the sealing element 10 by means of a bayonet lock 27. The bayonet lock 27 can in turn have a spring-elastic pretensioning element 33 in the form of a compression spring 34, by means of which the drying device 11 can be fixed to the sealing element 10.

Preferably, the drying device 11 is designed so that the temperature control agent can flow through it. For this purpose, the drying device 11 can, in a variant not shown in the figures, have an enclosure that is permeable to the temperature control agent T, which surrounds a granular drying agent 26, for example zeolites, molecular sieves, or silica gels, for absorbing moisture contained in the temperature control agent T. The enclosure may be made of a flexible material that is permeable to the temperature control agent. The enclosure may be formed by a bag made of fibrous material, for example of polyester, polyoxymethylene, or polyamide, or by a fine-mesh sieve, for example of polyester, polyoxymethylene, polyamide, or stainless steel.

In the example of FIG. 1, the housing 2 comprises two partitions 30a, 30b, which divide the housing interior 3 into a first, second, and third subspace 3a, 3b, 3c. The partitions 30a, 30b both extend from the top surface 6 to the bottom surface 7 and thus along a vertical direction V parallel to the direction of gravity G. The two partitions 30a, 30b are advantageously integrally formed on the housing 2 as shown, meaning that the two partitions 30a, 30b and the housing 2 are formed in one piece and from the same material.

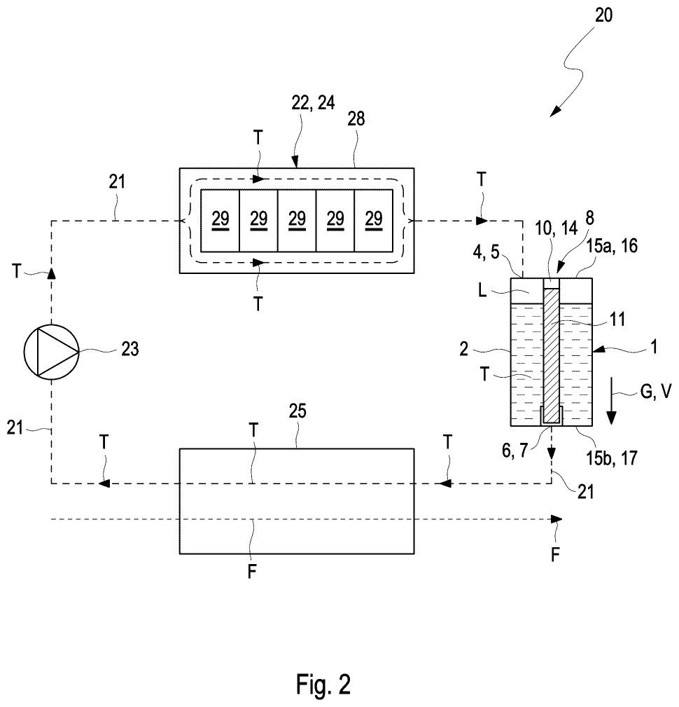

In order to ensure that all of the temperature control agent T present in the storage container 1 is also available for flowing through a temperature control circuit 21 (cf. FIG. 2), in which the storage container 1 is arranged, a breach 13 can be provided at a suitable point in each of the two partitions 30a, 30b, via which the first subspace 3a communicates fluidically with the second subspace 3b and the second subspace 3b with the third subspace 3c. Likewise, as shown in FIG. 1, a breach 13 can be provided in the second partition 30b, via which the air L present in the second subspace 3b can communicate fluidically with the air L present in the third subspace 3c. By means of the two partition walls 30a, 30b and the associated subdivision of the housing interior 3 into three separate subspaces 3a, 3b, 3c, unwanted movements of the temperature control agent T in the sense of unwanted “sloshing back and forth” and the possible leakage of air L from the storage container 1 that may accompany this are counteracted.

FIG. 2 shows an example of a temperature control arrangement 20 according to the invention in the form of a circuit diagram. The temperature control arrangement 20 comprises a temperature control circuit 21, in which the temperature control agent T circulates during operation of the temperature control arrangement 20 and in which the component 22 to be temperature-controlled is arranged. In this way, heat can be transferred between this component 22 and the temperature control agent T. This means that the component 22 can be temperature-controlled, and in particular cooled.

For example, the component 22 to be temperature-controlled can be an electric battery 24 of a battery-powered electric motor vehicle. However, the component 22 to be temperature-controlled can also be a fuel cell system with one or more fuel cells 29. In the example scenario, as indicated in FIG. 2, the component 22 to be temperature-controlled, i.e., the battery 24, is arranged in the temperature control circuit 21 so that the temperature control agent T can flow directly around it.

For this purpose, the battery 24 can have a battery housing 28 through which the temperature control agent T can flow, in which battery cells 29 to be temperature-controlled are arranged. Thus, the temperature control agent T flowing through the battery housing 28 can absorb heat from the battery cells 29 if they are to be cooled or release heat to the battery cells 29 if they are to be heated. This type of temperature control or cooling is known as “immersion cooling”.

Furthermore, the temperature control arrangement 20 comprises a conveying device 23 for circulating the temperature control agent T in the temperature control circuit 21. The conveying device may, for example, be a fluid or oil pump.

As can be seen from FIG. 2, the temperature control arrangement 20 also comprises an inventive storage container 1 arranged in the temperature control circuit 21 for the intermediate storage of the temperature control agent T, as explained above using FIG. 2 as an example. The storage container 1 can also function as an equalizing container in order to make further temperature control agent T available to the temperature control circuit 21 if a certain amount of temperature control agent has previously escaped from the temperature control circuit 21 due to leakage or other reasons.

Furthermore, a heat exchanger 25 through which the temperature control agent T can flow can be arranged in the temperature control circuit 21. The heat exchanger 25 can be fluidically separated from the temperature control agent T, and a fluid F can flow through it first, which can be thermally coupled to the temperature control agent T within the heat exchanger 25. In this way, heat can be transferred from the temperature control agent T to the fluid F in order to cool the temperature control agent T, or, conversely, heat can be transferred from the fluid F to the temperature control agent T if the temperature control agent T is to be heated.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

What is claimed is:

1. A storage container for holding a temperature control agent, the storage container comprising:
a housing that surrounds a housing interior through which the temperature control agent can flow for intermediate storage;
a fluid inlet arranged on the housing with an inlet opening for introducing the temperature control agent into the housing interior, and a fluid outlet arranged on the housing with an outlet opening for discharging the temperature control agent from the housing interior;
a housing opening in the housing, through which the housing interior communicates fluidically with an external environment of the housing;
a sealing element positioned in the housing opening, which seals the housing opening in a fluid-tight manner when arranged; and
a drying device for absorbing moisture from the temperature control agent present in the housing interior, arranged on the sealing element,
wherein the drying device is arranged in the housing interior while the sealing element is arranged in the housing opening.

2. The storage container according to claim 1, wherein the drying device allows the flow of the temperature control agent.

3. The storage container according to claim 2, wherein the drying device is partially positioned in a receptacle provided in the housing interior, the receptable being fluidically connected to the outlet opening, such that the temperature control agent flowing through the housing interior passes through the drying device before reaching the outlet opening.

4. The storage container according to claim 3, wherein the receptacle is an inward-projecting opening collar that extends from the housing into the housing interior, protruding from the inlet opening, and into which the drying device can be at least partially inserted.

5. The storage container according to claim 1, wherein the sealing element comprises a screw plug configured to be screwed into the housing opening.

6. The storage container according to claim 1, wherein the drying device protrudes into the housing interior while the sealing element is positioned in the housing opening.

7. The storage container according to claim 1, wherein the inlet opening and the housing opening are arranged in a first housing wall of the housing, and the outlet opening is arranged in a second housing wall of the housing, the second housing wall being opposite the first housing wall.

8. The storage container according to claim 7, wherein the drying device is elongated and extends from the first housing wall in a longitudinal direction towards the second housing wall.

9. The storage container according to claim 8, wherein the first housing wall comprises a top surface and the second housing wall comprises a bottom surface of the housing, with the top and bottom surfaces positioned relative to the direction of gravity in a position of use of the storage container.

10. The storage container according to claim 5, wherein the drying device comprises a permeable enclosure for the temperature control agent, which surrounds a drying agent for absorbing moisture contained in the drying agent.

11. The storage container according to claim 10, wherein the enclosure is made of a flexible material or comprises a flexible material.

12. The storage container according to claim 1, wherein the drying device is firmly connected to the sealing element.

13. The storage container according to claim 10, wherein the drying device is a detachable cartridge that can be removed from the sealing element or the screw plug, the cartridge comprising a cartridge housing that is permeable to the temperature control agent and contains the drying agent.

14. The storage container according to claim 13, wherein the drying device is removably attached to the sealing element via a bayonet lock.

15. The storage container according to claim 14, wherein the bayonet lock comprises a pretensioning element, the pretensioning element comprising a compression spring to secure the drying device to the sealing element.

16. A temperature control arrangement for controlling the temperature of at least one component, the temperature control arrangement comprising:
a temperature control circuit in which a temperature control agent circulates and transfers heat between at least one temperature-controlled component and the temperature control agent,
a conveying device for circulating the temperature control agent in the temperature control circuit, and
a storage container arranged in the temperature control circuit, the storage container comprising:
a housing that surrounds a housing interior through which the temperature control agent can flow for intermediate storage;
a fluid inlet arranged on the housing with an inlet opening for introducing the temperature control agent into the housing interior, and a fluid outlet arranged on the housing with an outlet opening for discharging the temperature control agent from the housing interior;
a housing opening in the housing, through which the housing interior communicates fluidically with an external environment of the housing;
a sealing element positioned in the housing opening, which seals the housing opening in a fluid-tight manner when arranged, and
a drying device for absorbing moisture from the temperature control agent present in the housing interior, arranged on the sealing element,
wherein the drying device is arranged in the housing interior while the sealing element is arranged in the housing opening.

17. The temperature control arrangement according to claim 16, wherein the temperature-controlled component is an electric battery or a fuel cell system with at least one fuel cell, for a motor vehicle.

18. The temperature control arrangement according to claim 16, wherein the temperature-controlled component is arranged in the temperature control circuit such that the temperature control agent flows directly around the component.

19. The temperature control arrangement according to claim 17, wherein the temperature-controlled component is arranged in the temperature control circuit such that the temperature control agent flows directly around the component.

20. The temperature control arrangement according to claim 16, wherein the drying device allows the flow of the temperature control agent.
